(19) United States
(12) Patent Application Publication
(10) Pub. No.: US 2026/0251778 A1
(43) Pub. Date: Aug. 27, 2026

(54) SYSTEMS AND METHODS FOR DYNAMICALLY ADJUSTING CUTTER ASSEMBLIES OF AGRICULTURAL VEHICLES

(71) Applicant: Deere & Company, Moline, IL (US)

(72) Inventors: KV Venkata Sanjay, Pune (IN); Mahesh S. Bothe, Pune (IN); Rasika Wagh, Pune (IN)

(21) Appl. No.: 19/065,111

(22) Filed: Feb. 27, 2025

(51) Int. Cl. G01S 13/88; A01D 45/10

(52) U.S. Cl. CPC G01S 13/88; A01D 45/10

(57) ABSTRACT

An agricultural vehicle is equipped with a system for dynamically adjusting the height of a cutter assembly, such as a topper assembly, to optimize the cutting of crop material. The system can employ radar-based crop sensors to gather, as crop material is being harvested, spatial and signal strength information for a point cloud dataset. The collected information allows for a differentiation between, and corresponding location identifications for, stalks and leaves of the crop material based at least on differences in dielectric properties. This information can identify the locations of transitions between stalks and leaves, and thus target cutting heights, which can change based on variations in the characteristics of the crop material being harvested. As crop material is being harvested, the height of the cutter assembly can be adjusted to reflect changes in the target cutting height, which can minimize the intake of undesirable leaves and improve crop yield estimations.

### FIELD OF THE DISCLOSURE

The present disclosure generally relates to harvesting agricultural material, and, more specifically, to systems and methods for dynamically adjusting a cutting height setting for one or more cutters of an agricultural vehicle.

### BACKGROUND

Stalk-like crop materials, including, for example, sugar cane, among others, can be harvested using agricultural vehicles, such as sugarcane harvesters, that can include a base cutter assembly that severs the crop material from the ground. Such agricultural vehicles can also include a top cutter assembly that cuts leaves that can be present on the crop material, including leaves that can be or around a top portion of the stalk of the crop material. The severed crop material, including the stalk and leaves remaining on the stalk, can then be ingested by the agricultural vehicle, or another agricultural vehicle or tool, and be subjected together to further processing, such as, for example, threshing, separation, and cleaning operations, among other operations. In such instances, at least portions of the leaves processed with the stalk can be intermixed with the resulting harvested crop material.

### SUMMARY

The present disclosure can comprise one or more of the following features and combinations thereof.

In one embodiment of the present disclosure, an agricultural vehicle is provided that includes a cutter assembly that is configured to separate a second portion of a crop material of a first plurality of crop material from a first portion of the crop material of the first plurality of crop material, and a crop sensor configured to transmit, during a harvesting operation, a first plurality of transmitted signals and receive a first plurality of reflected signals. The agricultural vehicle can further include at least one processor, and a memory coupled with the at least one processor. The memory can include instructions that when executed by the at least one processor cause the at least one processor to determine, for each reflected signal of the first plurality of reflected signals: (1) a location corresponding to a reflection of the reflected signal, and (2) a dielectric constant corresponding to a signal strength of the reflected signal. Additionally, the memory can include instructions that when executed by the at least one processor cause the at least one processor to determine, from the location and the dielectric constant determined for at least some reflected signals of the first plurality of reflected signals, a first target cutting height for separating the second portion from the first portion of the crop material of the first plurality of crop material, and generate one or more signals to adjust a cutting height setting for the cutter assembly using the first target cutting height.

According to another embodiment of the present disclosure, a method is provided for dynamically adjusting a cutting height of a cutter assembly of an agricultural vehicle. The method can include receiving, by a crop sensor during a harvesting operation, a plurality of reflected signals reflected from an agricultural environment, and determining, by a controller, for each of at least some reflected signals of the plurality of reflected signals, a dielectric constant corresponding to a signal strength of the reflected signal. The method can further include identifying, by the controller using the dielectric constant of the at least some reflected signals, a first group of reflected signals and a second group of reflected signals, and identifying, using a location derived from each of the at least some reflected signals, a transition location or a separation location between the first group of reflected signals and the second group of reflected signals along a crop material in the agricultural environment. Additionally, the method can include determining, from the transition location or the separation location, a target cutting height for the crop material, and adjusting, in response to a signal generated by the controller, the cutting height of the cutter assembly to set the cutter assembly to cut the crop material at the target cutting height.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements can be exaggerated relative to other elements for clarity. Further, where considered appropriate, reference labels have been repeated among the figures to indicate corresponding or analogous elements.

FIG. 1 illustrates a right side elevational view of an exemplary agricultural vehicle in the form of a sugarcane harvester.

FIG. 2 illustrates a fragmentary right side elevational view of exemplary connections between the main frame and a topper assembly of the agricultural vehicle shown in FIG. 1.

FIG. 3 illustrates a schematic top view of the front wheels, crop dividers and topper assembly for the agricultural vehicle shown in FIG. 1.

FIG. 4 illustrates a simplified block diagram of an exemplary system for dynamically adjusting a cutting height setting for one or more cutters of an agricultural vehicle.

FIG. 5 illustrates a simplified flow diagram of an exemplary method for dynamically adjusting a cutting height setting for one or more cutters of an agricultural vehicle.

FIG. 6 illustrates a simplified representation of a sensor of the exemplary agricultural vehicle collecting information regarding crop material upstream the agricultural vehicle.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described can include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features can be shown in specific arrangements and/or orderings. However, it should be appreciated that such specific arrangements and/or orderings may not be required. Rather, in some embodiments, such features can be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Embodiments of the subject disclosure generally relate to a system that automates the adjustment of the cutting height of a cutter assembly, such as, for example, a topper assembly, of an agricultural vehicle in connection with harvesting a crop material, such as a stalk type crop material, including, but not limited to, sugarcane. For example, with respect to sugarcane, the height or location of sugarcane leaves relative to the stalk of the crop material can vary, such as, for example, due to down crop, uneven crop growth, and/or environmental factors, among other causes for variation. As a consequence, the leaves ingested by the agricultural vehicle with the stalk can end up as trash in the corresponding harvested billets.

The disclosed system therefore incorporates one or more crop sensors, such as, for example, a radar-based sensor(s), to address challenges relating to non-uniform crop height in a manner that does not necessitate manual adjustment in cutter settings by the operator of the vehicle. The crop sensor can be positioned to obtain information, including data, in a generally forward direction with respect to at least a direction of travel of the agricultural vehicle while harvesting crop material. Further, the crop sensor can collect spatial location information and signal magnitude information that the system can use to distinguish between different portions of the crop material, including the stalks from the leaves, or vice versa. By distinguishing between different portions of the crop material, including distinguishing between the stalks and the leaves, the system can determine a dynamically adjustable target cutting height for cutting the crop material. The resulting information facilitates a dynamic, and automatic, adjustment by the system of the topper assembly height. Such dynamic cutter height adjustments can optimize the cutter placement to cut precisely above the stalks, at a location between the stalks and the leaves. The improved accuracy in the cutting location can reduce the amount of leaves or trash ingested by the agricultural vehicle with the stalk, which can improve the accuracy of crop yield estimations. Further, automatically, rather than manually, adjusting the height of the topper assembly to accurately correspond to a location at which leaves are to be separated from the stalk can reduce an operation burden on the operator.

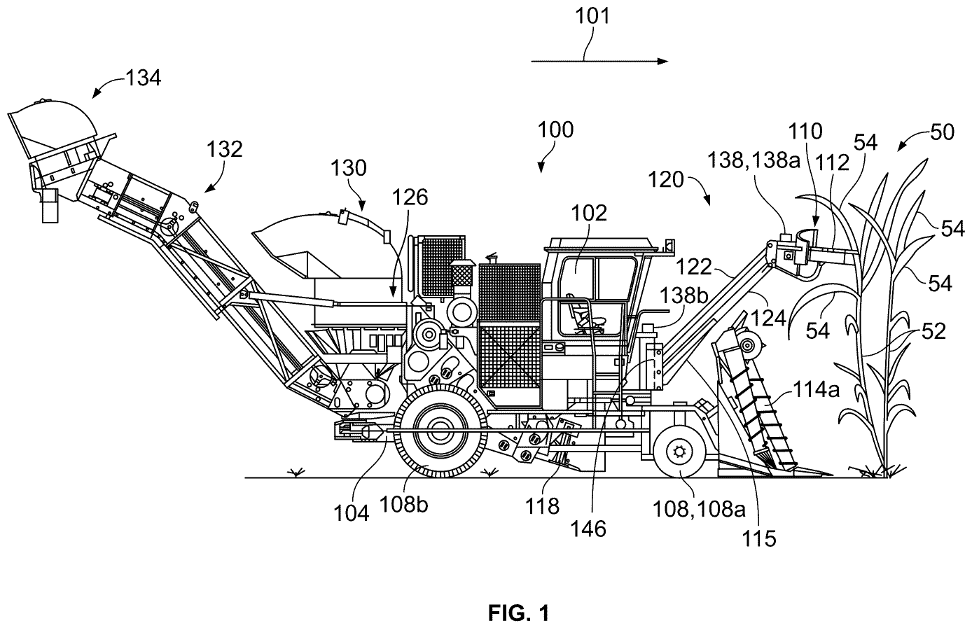

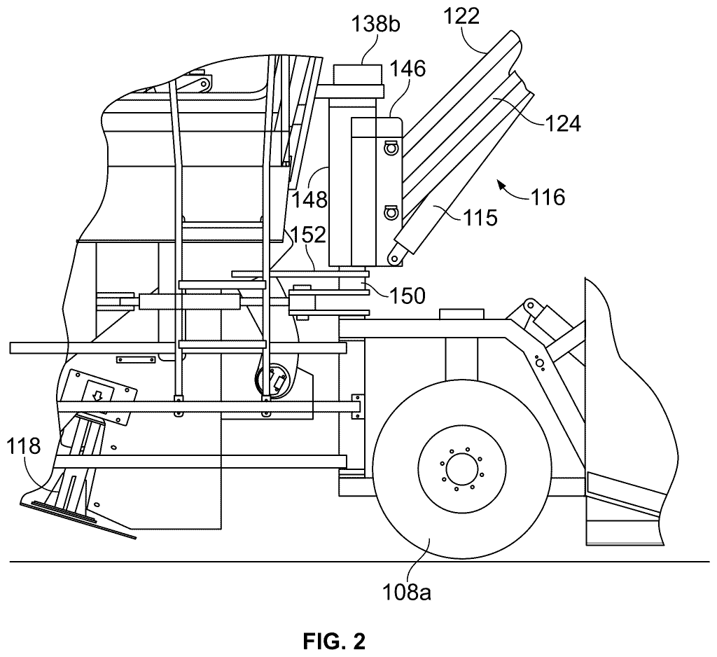

FIGS. 1, 2, and 3 illustrate an exemplary agricultural vehicle 100 for harvesting at least one type of agricultural material. Moreover, FIG. 1 illustrates an exemplary agricultural vehicle 100 in the form of a sugarcane harvester configured for harvesting sugarcane. While FIG. 1 illustrates one type of harvester for the agricultural vehicle 100, other harvesters can be utilized in place of the illustrated sugarcane harvester, including, for example, harvesters or combines utilized to harvest other types of agricultural material. Additionally, while the agricultural vehicle 100 is discussed below in connection with a particular type of conveyance assembly for transporting the harvested agricultural material about the agricultural vehicle 100, other types of conveyance assemblies can be utilized, including, for example, conveyance assemblies associated with other types of agricultural materials.

The illustrated agricultural vehicle 100 can include a cab 102 to seat an operator, as well as a main frame 104 for supporting various cutting, routing, and processing devices. In certain embodiments, the main frame 104 can be supported by a transport frame, such as a track frame, that can support ground engagement bodies 108, such as, for example, track assemblies or front or rear wheels 108a, 108b, that contact, and are utilized in the propulsion of the agricultural vehicle 100 along, a ground surface. Thus, the agricultural vehicle 100 can include an engine (not shown) that can provide power for driving at least the ground engagement bodies 108, 108b, among other driven components of the agricultural vehicle 100.

The illustrated agricultural vehicle 100 can include crop dividers 114 that can be coupled to the main frame 104. The crop dividers 114 can be configured to divide the agricultural material being harvested using the agricultural vehicle 100 into separate rows so as to at least attempt to prevent uprooting of the agricultural material. The height of the crop dividers 114 relative to at least the adjacent ground surface or main frame 104 of the agricultural vehicle 100 can be selectively adjusted by an operator of the agricultural vehicle 100, such as, for example, via operation of one or more actuators. Additionally, according to certain embodiments, such height adjustment of the crop dividers 114 can be independent of an adjustment to the height, if any, of the overall agricultural vehicle 100, a topper assembly 110, and/or of one or more other crop dividers 114.

A knockdown roller (not shown) of the agricultural vehicle 100 can be configured to push the agricultural material being harvested from the field in a generally forward direction so that base cutters 118 of the agricultural vehicle 100 can at least attempt to cut the agricultural material in the field at, or around, ground level. According to certain embodiments, the base cutters 118, which can be coupled to the main frame 104, can be configured to cut the agricultural material in a substantially horizontal plane. The base cutters 118 can comprise a plurality of base cutters 118, such as, for example, one or more right and left side base cutters 118. According to certain embodiments, the height of the base cutters 118, including with respect to the adjacent ground surface, can be independent or dependent on the height of the agricultural vehicle 100. The agricultural vehicle 100 can also include side knives that can be configured to cut agricultural material in a vertical plane substantially parallel with a travel path of the agricultural vehicle 100.

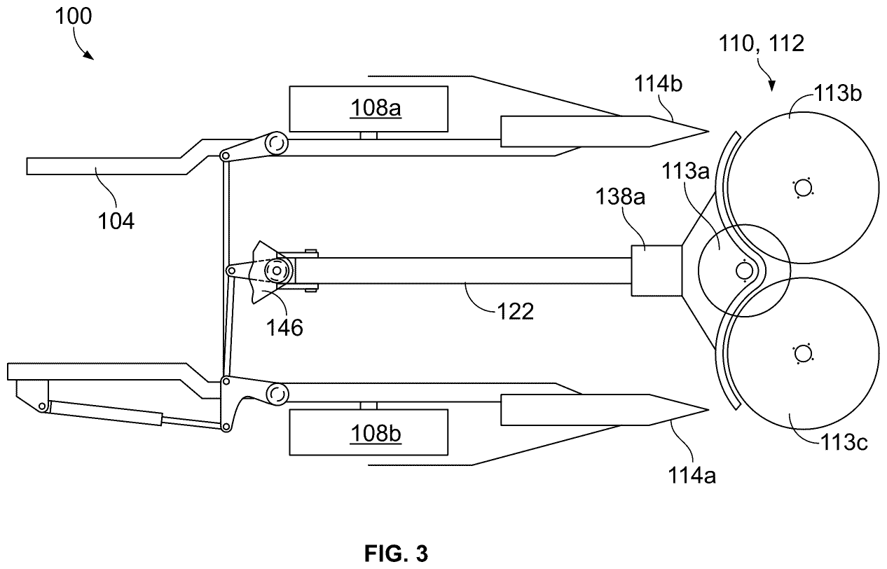

The illustrated exemplary agricultural vehicle 100 can include a topper assembly 110 that extends forward of the main frame 104. The topper assembly 110 can be configured to cut leaves off of the top or upper areas of the agricultural material being harvested, including, for example, a stalk(s). As seen in FIG. 3, according to certain embodiments, the topper assembly 110 can include a cutting head 112 that can include one or more, if not a plurality, of cutting disks 113a, 113b, 113c that can be configured to cut the tops of the agricultural material being harvested, as well as to assist in discharging the cut portion(s) of the agricultural material to an adjacent portion of the field in which other agricultural material may have already been harvested. As discussed herein, a height of at least a portion of the topper assembly 110, such as, for example, the cutting head 112, including one or more, if not all, of the disks 113a, 113b, 113c, can be dynamically, including proactively, adjusted. For example, as discussed below, a height at which the topper assembly 110 is to cut crop material can be dynamically adjusted to varying target cutting heights that can generally correspond to identified locations, including transitions, between a first portion of the crop material, such as, for example, a stalk(s), and a second portion of the crop material, such as, for example, leaves. Such adjustment of at least a portion of the topper assembly 110 can be independent of adjustments to the height of the agricultural vehicle 100 or portions of the agricultural vehicle 100, including other systems or assemblies of the agricultural vehicle 100.

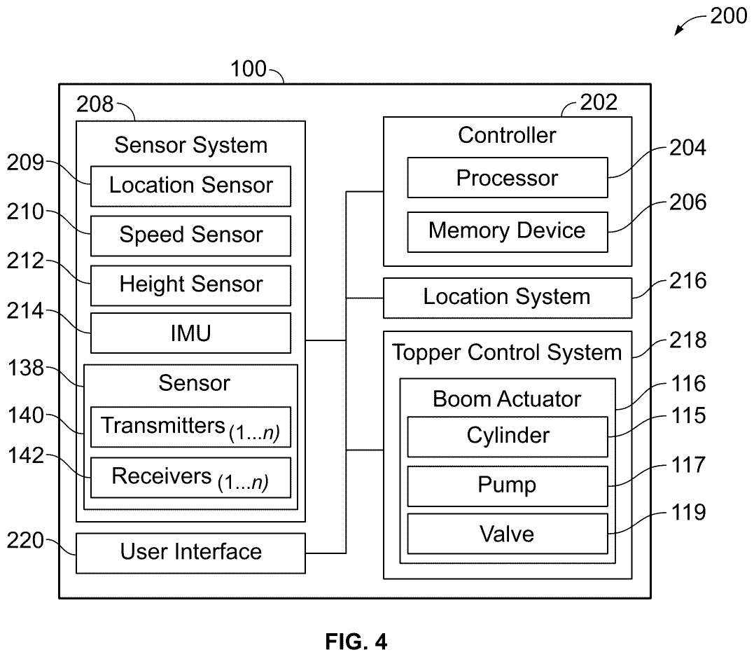

The cutting head 112 of the topper assembly 110 can be coupled to the main frame 104 by a boom 120. According to the illustrated example, the boom 120, which can be part of a topper control system 218 (FIG. 4), can, according to certain embodiments, include an upper arm 122 and a lower arm 124, respectively. For at least certain types of agricultural vehicle 100, the rear ends of the arms 122, 124 can be pivotally coupled to a swing frame 146. The swing frame 146 can include a tubular member 148 mounted for rotatable or swinging displacement of at least a portion of the swing frame 146, and thus the boom 120, about a vertical axis defined by a cylindrical support post 150 that can be fixed to a central location of the main frame 104 below a lower region of the cab 102. Additionally, the boom 120, including, for example, the lower arm 124, can be coupled to a boom actuator 116 that can also be coupled to the swing frame 146 or main frame 104. The boom actuator 116, which can, for example, be a hydraulically or pneumatically actuated cylinder 115 (FIG. 4), can be selectively actuated to control an operating height of the topper assembly 110, and, moreover, of the cutting head 112. Thus, as seen in FIG. 4, according to certain embodiments in which the boom actuator 116 includes a hydraulically or pneumatically actuated cylinder 115, the boom actuator 116 can, for example, be fluidly coupled to a pump 117 and one or more valves 119, among other components of an associated fluid circuit. At least such components of the fluid circuit can be selectively actuated, such as, for example, by one or more signals from a controller 202, to control a flow of fluid to, or from, a chamber of the boom actuator 116. Such control of fluid flow can control the positioning of the cylinder rod (e.g., in a retracted or extended position, as well as positions therebetween) relative to at least the chamber of the cylinder 115) in a manner that can facilitate pivotal displacement of the boom 120 to selectively alter a vertical height or position of the topper assembly 110, and thus the cutting head 112 and associated disks 113a, 113b, 113c. However, the boom actuator 116 can take a variety of other forms, including, for example, being a motor or engine, that can be used to control the height of the topper assembly 110, including via use of one or more linkages or cables that are coupled to the boom actuator 116, among other manners of control.

During operation of the agricultural vehicle 100, as the agricultural vehicle 100 travels toward crop materials 50, as generally indicated in FIG. 1 by forward direction 101, the cutting head 112 of the topper assembly 110 can be positioned to sever at least a first portion (e.g., stalk) from a second portion (e.g., leaves) of a collection of upcoming crop material 50. For example, with respect to sugarcane, the topper assembly 110 can be positioned to at least attempt to cut the approaching crop material 50 at a transition location between the stalk 52 and the higher leaves 54 of the crop material 50. Further, the crop divider assemblies 114a, 114b can move to a position at which the sugarcane, which may have now been cut by the cutting head 112 of the topper assembly 110, straddle a row of the cane stalks, which can then pass beneath the frame 104 and be severed from the ground by the base cutter units 118. The severed stalks can be delivered to a feed roller assembly (not shown) that transports the cut cane stalks to a chopper assembly 126. The chopper assembly 126 can cut the cane stalks into lengths called billets, which can then be fed into a primary extractor assembly 130. The primary extractor assembly 130 can operate to clean unwanted material, such as, for example, leaves 54 that were below the location at which the topper assembly 110 cut the crop material 50, among other crop pieces, from the billets.

The billets can then pass into a loading elevator assembly 132 and to a secondary extractor assembly 134. The secondary extractor assembly 134 can act to extract further trash, including remaining portions of leaves, from the billets as the billets are conveyed from the agricultural vehicle 100 and to a wagon.

FIG. 4 illustrates a simplified block diagram of an exemplary system 200 for dynamically adjusting a cutting height setting for one or more cutters of an agricultural vehicle 100. The system 200 can include one or more controllers 202 having at least one processor 204 and at least one memory device 206. The controller 202, processor(s) 204, and/or memory device(s) 206 may, or may not, be dedicated to the operation of the system 200, or components of the system 200, including the agricultural vehicle 100. For example, while, for at least purposes of simplicity of illustration, FIG. 4 depicts a controller 202 coupled to the topper control system 218, among other components of the system 200, according to certain embodiments, the controller 202 may, or may not, include a controller dedicated to the topper control system 218. Thus, for example, according to certain embodiments, the processor 204 can comprise one or more processors, including compute circuits, that can be utilized to control operation of the system 200, and, optionally, can also be utilized in connection with controlling the operation of one or more components agricultural vehicle 100, including, but not limited to, the height(s) of the topper assembly 110, or one or more, if not all, of the disks 113a, 113b, 113c of the topper assembly 110, among other components. Therefore, according to certain embodiments, one controller 202, including one or more processors 204 of that controller 202, can be utilized to control operation of at least the system 200, or the corresponding components of the system 200. Alternatively, a plurality of controllers 202, or combinations of processors 204, including compute circuits, can be utilized to control operation of the system 200, as well as control operations of different components of the agricultural vehicle 100. Thus, for example, while certain embodiments herein may mention functions being performed by a controller 202, including the associated processor 204, such functions can be performed by a single controller or processor, or, alternatively, one or more functions can be performed by one or more controllers or processors, and one or more other functions can be performed by one or more other controllers or processors or combinations of controllers or processors.

The memory device 206 can have instructions stored therein that are executable by the processor 204 to cause the processor 204 to receive input, such as, for example, from one or more sensors, such as, for example, sensors 138, 210, 212, 214 of the below-discussed sensor system 208 or a location system 216, as well as any combination thereof, among other inputs. The processor 204 can be embodied as, or otherwise include any type of processor, controller, or other compute circuit capable of performing various tasks such as compute functions and/or controlling the functions of at least the system 200. For example, the processor 204 can be embodied as a single or multi-core processor(s), a microcontroller, or other processor or processing/controlling circuit. In some embodiments, the processor 204 can be embodied as, include, or otherwise be coupled to an FPGA, an application specific integrated circuit (ASIC), reconfigurable hardware or hardware circuitry, or other specialized hardware to facilitate performance of the functions described herein. Additionally, in some embodiments, the processor 204 can be embodied as, or otherwise include a high-power processor, an accelerator co-processor, or a storage controller.

The memory device 206 can be embodied as any type of volatile (e.g., dynamic random-access memory (DRAM), etc.) or non-volatile memory capable of storing data therein. Volatile memory can be embodied as a storage medium that requires power to maintain the state of data stored by the medium. Non-limiting examples of volatile memory can include various types of random-access memory (RAM), such as dynamic random-access memory (DRAM) or static random-access memory (SRAM). One particular type of DRAM that can be used in a memory module is synchronous dynamic random-access memory (SDRAM).

In some embodiments, the memory device 206 can be embodied as a block addressable memory, such as those based on NAND or NOR technologies. The memory device 206 can also include future generation nonvolatile devices, such as a three-dimensional crosspoint memory device (e.g., Intel 3D XPoint™ memory), or other byte addressable write-in-place nonvolatile memory devices. In some embodiments, the memory device 206 can be embodied as, or can otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device 206 can refer to the die itself and/or to a packaged memory product. In some embodiments, 3D crosspoint memory (e.g., Intel 3D XPoint™ memory) can comprise a transistor-less stackable cross point architecture in which memory cells sit at the intersection of word lines and bit lines and are individually addressable and in which bit storage is based on a change in bulk resistance.

As seen in at least FIG. 4, the agricultural vehicle 100 can include a plurality of sensors 138, 209, 210, 212, 214, which, for at least purposes of discussion, can be referred to herein as being part of a sensor system 208. The below mentioned exemplary components of the sensor system 208 can be communicatively connected to the controller 202 to communicate sensed information, including sensed data, via a wired and/or wireless connection.

The sensor system 208 can include a location sensor or receiver 209 that can be positioned on the agricultural vehicle 100, such as, for example, on a roof of the cab 102. Although illustrated in FIG. 4 as being part of a sensor system 208, the location sensor 209 can be part of a location system 216, such as, for example, a global positioning system (GPS) of the agricultural vehicle 100. Further, according to certain embodiments, the location sensor 209 can be utilized to connect the location system 216 to, and/or receive information from, one or more GPS satellites. Information provided by the location system 216 or the location sensor 209 can indicate a location of the agricultural vehicle 100, including, but not limited, coordinates that can comprise one or more, if not all, of a longitudinal location, latitudinal location, and elevation of the agricultural vehicle 100. Further, information provided by the location system 216 or the location sensor 209 can also be used to determine a direction of travel, heading or compass bearing, of the agricultural vehicle 100, among other information.

The sensor system 208 can further include a speed sensor 210 that can be utilized to identify a speed of travel of the agricultural vehicle 100, including a ground speed of the agricultural vehicle 100. For example, according to certain embodiments, the speed sensor 210 can be a radar based speed sensor, or an inertial measurement unit (IMU) 214, among other types of speed sensors. For example, with respect to embodiments in which the IMU 214 is utilized as a speed sensor 210, one or more accelerometers of the IMU 214 can provide information regarding a measured linear acceleration of the agricultural vehicle 100, which, over a time period, can be used to determine a velocity of the agricultural vehicle 100. However, such speed information can also be attained in a variety of different manners, including using information from the location system 216, such as, for example, GPS information over or between a period of time.

The sensor system 208 can also include one or more, including a plurality of position or height sensors 212. For example, according to certain embodiments, one or more first height sensors 212 can be utilized to identify a height of the topper assembly 110, such as, for example, a height of the topper assembly 110, or one or more of the disks 113a, 113b, 113c of the topper assembly 110, relative to the adjacent ground surface or other portion of the agricultural vehicle 100. However, the height of the topper assembly 110, or portions thereof, including, for example, the disks 113a, 113b, 113c, can be determined in a variety of other manners. For example, according to certain embodiments, the height of the topper assembly 110 can be determined based on the extension length of the cylinder 115, and, moreover, the cylinder rod or piston, of the boom actuator 116. The height of the topper assembly 110 can also be determined using the known geometry of the agricultural vehicle 100 and its associated components. For example, the determination of the height of the topper assembly 110 can involve known pivot positions of the boom actuator 116 relative to the main frame 104 and/or swing frame 146, and the known extent of the extension or retraction of the cylinder 115, which can be correlated with an angular displacement of the boom 120.

The system 200 can also include a user interface 220 that an operator can use to interact with the controller 202. The user interface 220 can include one or more input/output (I/O) devices, such as, for example, a steering wheel, joystick, button, keyboard, mouse, touch screen, display, microphone, and speaker, among other I/O devices. The user interface 220 can be utilize by the operator to input or otherwise provide a variety of information to the controller 202 that can also be stored for historical purposes, including, but not limited to, information regarding operator preferences, as discussed below.

In addition to, or in lieu of, providing information used to determine the speed of the agricultural vehicle 100, the IMU 214 can provide information regarding at least an orientation of at least a portion of the agricultural vehicle 100. Moreover, the IMU 214 can integrate a combination of accelerometers, gyroscopes, and potentially magnetometers to provide information that can be utilized by the controller 202 to determine the dynamic position and movement characteristics of the topper assembly 110, including, for example, with respect to a pitch, roll, and yaw of the agricultural vehicle 100, including with respect to the topper assembly 110 or portion thereof, including the cutting head 112. The IMU 214 can assist in the system 200 compensating for changes in terrain and movement of the agricultural vehicle 100, ensuring accurate positional adjustments during operation, thereby enhancing the accuracy of the positioning of at least the topper assembly 110.

The sensor system 208 can further include one or more crop sensors 138 having a plurality of transmitters 140 and a plurality of receivers 142. According to certain embodiments, the crop sensor 138 can be a radar based sensor, including, but not limited to, an ultrawide band (UWB) radar, among other types of radars or sensors using radar technology. However, a variety of other types of sensors can be utilized as the crop sensor 138, including sensors that can utilize lidar or ultrasound waves, among other types of sensors.

The transmitters 140 are configured to emit a signal(s), such as, for example, radar signals, including electromagnetic waves, that can propagate through the agricultural environment, impinging upon crop materials, such as the first portion (e.g., stalks 52) and second portion (e.g., leaves 54) of the crop material 50. The receivers 142 are configured to capture the reflected signals that were emitted from the transmitters 140, including the electromagnetic waves that are reflected back from various portions of the crop material 50, including the stalks 52 and leaves 54, among other items that can be in, or around, the agricultural environment. As discussed below, the signals received by the receivers 142 can be used by the controller 202 to detect the presence and characteristics of the materials, including the crop material 50, within the field of view of the crop sensor 138.

The crop sensor 138 can be positioned at various locations on the agricultural vehicle 100. According to certain embodiments, the crop sensor 138 can be positioned such that the crop sensor 138 can have a view that is generally aligned with the forward direction of travel 101 of the agricultural vehicle 100 and/or with respect to the movement of the topper assembly 110, as seen in FIG. 1. Such positioning can, for example, facilitate the effective transmission of signals by the transmitters 140, as well as capture of reflected signals by the receivers 142 of the crop sensor 138 in connection with enabling the system 200 to perform automated dynamic adjustments of the height of the topper assembly 110, as discussed herein.

For example, as seen in at least FIGS. 1 and 3, according to certain embodiments, a crop sensor 138a can be positioned on, or integrated within, the topper assembly 110, including, for example, near or on top of the cutting head 112, or on the boom 120. Alternatively, or additionally, according to certain embodiments, a crop sensor 138b can be mounted on the main frame 104 or other structural elements of the agricultural vehicle 100 to optimize its field of view. For example, as seen in FIG. 1, according to certain embodiments, a crop sensor 138b can be positioned at a forward portion of the agricultural vehicle 100 below the cab 102.

The information obtained by the crop sensor 138 can be used to form a point cloud dataset for the sensed area. As discussed below, information gathered for the point cloud dataset from at least the crop sensor 138 can enable the differentiation between at least first portions (e.g., stalks 52) and second portions (e.g., leaves 54) of the crop material 50 based on their respective spatial coordinates and different dielectric properties. Thus, for example, the controller 202 can process either or both the magnitude and phase of the reflected signals to estimate the dielectric constant of the materials, which can, for example, be influenced by differences in the moisture content and structural density among the first and second portions of the crop material 50.

By utilizing such spatial and dielectric property information, the system 200 can have an enhanced resolution and accuracy of detected objects within the scope of the crop sensor 138, which can be used to automatically adjust the location at which the topper assembly 110 cuts the crop material 50. This approach allows the system 200 to dynamically adjust the cutting height, optimizing the removal of leaves 54 while preserving the integrity of stalk 52, thereby facilitating efficient harvesting operations.

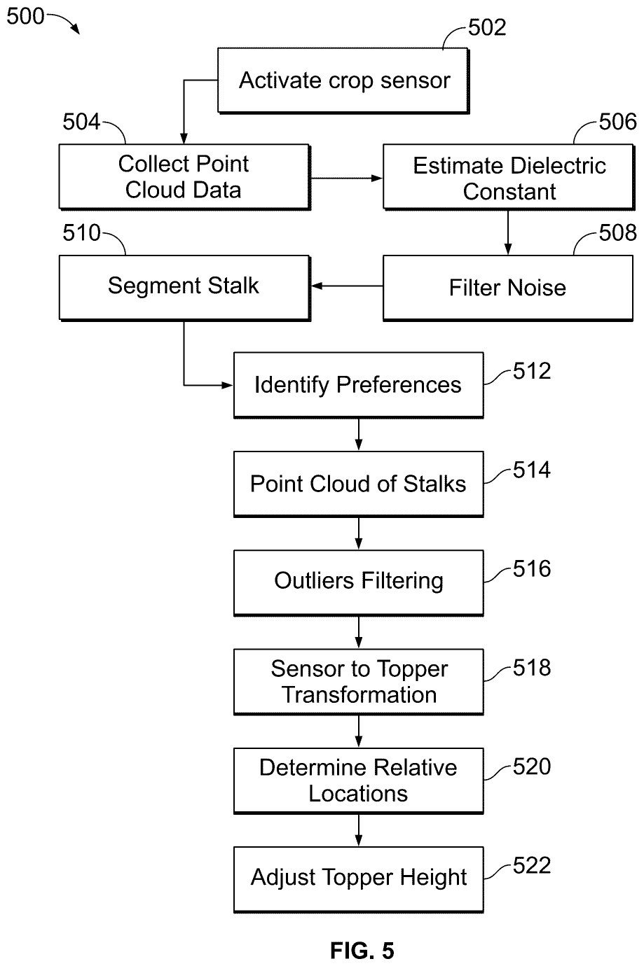

FIG. 5 illustrates a simplified flow diagram of an exemplary method 500 for dynamically adjusting a cutting height setting for one or more cutters of an agricultural vehicle. The method 500 is described below in the context of being carried out by the illustrated exemplary system 200, and, moreover, with respect to proactively adjusting a cutting height of the topper assembly 110. However, it should be appreciated that method 500 can likewise be carried out by any of the other described implementations, as well as variations thereof. Further, the method 500 corresponds to, or is otherwise associated with, performance of the blocks described below in the illustrative sequence of FIG. 5. It should be appreciated, however, that the method 500 can be performed in one or more sequences different from the illustrative sequence. Additionally, one or more of the blocks mentioned below may not be performed, and the method 500 can include steps or processes other than those discussed below.

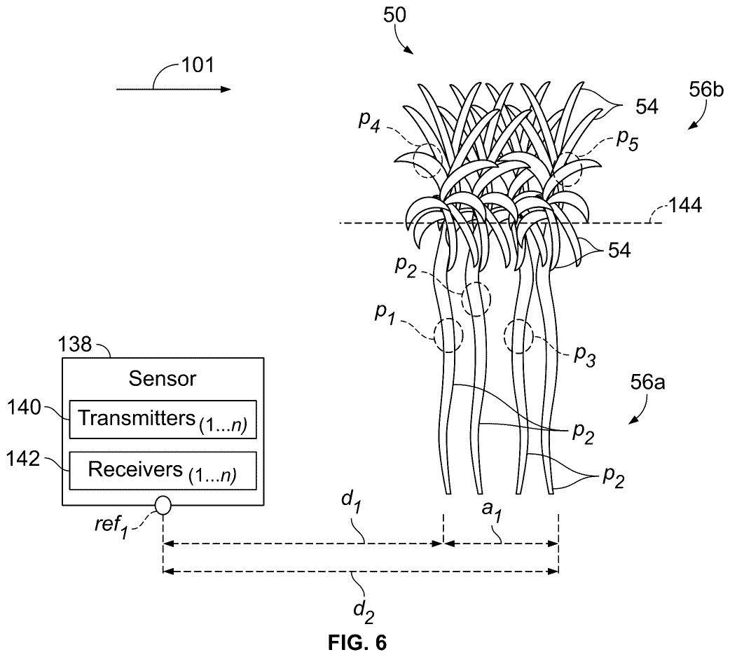

At block 502, the crop sensor 138 is activated to commence the collection of information used to determine spatial location information and signal magnitude information, including data. This activation can enable the crop sensor 138 to transmit signals via a plurality of transmitters 140, as generally indicated in FIGS. 4 and 6 by “Transmitters_{(1 . . . n})”. For example, with respect to at least embodiments in which the crop sensor 138 utilizes UWB radar, the signals transmitted at block 502 can be electromagnetic waves that can propagate through the agricultural environment, with the reflected signals (e.g., electromagnetic) subsequently being received the with a plurality of receivers 142, as generally indicated in FIGS. 4 and 6 by “Receivers_{(1 . . . n})”. For example, FIG. 6 illustrates a simplified representation of a crop sensor 138 collecting information, here generally represented, for example, as data points (e.g., p₁, p₂, p₃, p₄, p₅ . . . pₙ) regarding crop material 50 upstream the agricultural vehicle 100.

As discussed below, the collected information (e.g., data points p₁-pₙ) can facilitate, at block 504, the creation of the point cloud dataset that aids with distinguishing between the stalks 52 and leaves 54 that are within the view of the crop sensor 138. The information, including data points, obtained by operation of the crop sensor 138 can be collected by, or for, for a point cloud dataset at block 504. The information collected from crop sensor 138 can provide at least two pieces of information. First, as discussed below, the information can be used to determine a location, including a spatial location, from which signal emitted from the transmitters 140 is reflecting back to the receivers 142. Such spatial location can include information along a three-dimensional coordinate system. For example, according to certain embodiments, the spatial information can be used to identify a location along a multiple axis coordinate system, including along three axes of an x-y-z coordinate system, among other coordinate systems. Such information can be used to generate, including map, the received information, including used to generate a three-dimensional map.

Second, as also discussed below, the information obtained by the crop sensor 138 a block 504 can include information regarding a strength or magnitude of the signal, or wave, reflected to, or received by, the receivers 142. As discussed below, such signal strength can be correlated to an associated value of a dielectric constant, and, moreover, to a dielectric constant corresponding to an item or element, including a crop element, from which the signal emitted by the transmitters 140 is reflected back to the receivers 142. For example, the strength of the signals received by the receivers 142 that reflected off of a first portion 56a (FIG. 6) of the crop material 50, such as, for example, moisture-laden stalks 52, can have a different signal strength than signals received by the receivers 142 that reflected off of a second portion 56b (FIG. 6) of the crop material 50, such as, for example, off of the leaves 54. Such differences in signal strength, and an identification of whether the signal strengths, or the associated derived dielectric constants, satisfy one or more predetermined thresholds, including ranges of thresholds, can allow for precise differentiation by the controller 202 of which information, including corresponding location data, corresponds to the first portion (e.g., stalk 52), and which corresponds to the second portion (e.g., leaves 54) of the crop material 50. Such predetermined thresholds can, for example, be determined prior to performance of the method 500, including, for example via a calibration process.

A determination of the dielectric constant in view of the corresponding spatial location, can thus assist in identifying the type of crop element (e.g., stalk 52 or leaf 54) present at the associated identified spatial location of that crop element, which can assist in determining where the topper assembly 110 is to cut the second portion 56b (e.g., leaves 54) from the first portion 56a (e.g., stalk 52) of the crop material 50. Such precise cutting locations can promote efficient and accurate harvesting of crop material 50 while minimizing harvesting of waste.

At block 506, the information collected from the operation of the crop sensor 138 a block 502, or otherwise collected for the point cloud dataset at block 504, can be used by the controller 202 to determine, including estimate, a dielectric constant for the corresponding crop elements. The determination of the dielectric constants can be executed by analyzing the strength and characteristics of reflected signals, such as, for example, radar signals, captured by the receivers 142. The dielectric constant can, for example, provide insights into the material composition and moisture content of the crop elements. For example, sugarcane stalks 52, which generally possess higher moisture content than the leaves 54, can exhibit a higher dielectric constant relative to leaves 54. The controller 202 can therefore employ one or more algorithms to calculate, from the strength of the signals received by the receivers 142, the dielectric constant, thereby enabling differentiation between different crop elements. For example, according to certain embodiments, dielectric constants identified by the controller 202 as satisfying a first threshold value, including being above a first threshold value (e.g., x₁) or within a range of first threshold values (e.g., between x₁-x₂), can be predetermined to correspond to the first portion 56a (e.g., stalk 52) of the crop material 50. Similarly, crop elements identified by the controller 202 as satisfying a second threshold value (e.g., y₁), including being below the second threshold value or within a range of second threshold values (e.g., between y₁-y₂), can be predetermined to correspond to the second portion 56b (e.g., leaves 54) of the crop material 50. Further, according to certain embodiments, the second value (e.g., y₁) can be different than the first value (e.g., x₁), including being lower than the first value.

A filtering process can be enacted at block 508 that can target and remove noise from the point cloud dataset. The filtering of noise can involve assessing spatial and signal strength information, and, to the extent derived, dielectric constant information, in the information in the point cloud dataset. Threshold values, including ranges of threshold values, for dielectric constants corresponding to certain crop elements, such as, for example, stalks 52 and leaves 54, can be predefined and utilized in the filtering process. Information, including data points in the point cloud dataset falling outside of the predefined threshold values can be identified by the controller 202 as noise, or as corresponding to information pertaining to non-targeted elements within the agricultural environment, such as, for example, the ground or debris, among other objects. The filtering of noise at block 508 can also include information relating to spatial data that is outside of anticipated thresholds, such as, for example, being above or below predetermined thresholds.

At block 510, the information collected in the point cloud dataset can be segmented to identify the location(s) of a transition area between the first portion 56a (e.g., stalks 52) and the second portion 56b (e.g., leaves 54) of the crop material 50. This segmentation process can utilize the previously determined spatial coordinates and dielectric constants (e.g., from blocks 504 and 506) to establish a boundary that distinguishes information corresponding to a location(s) separation, including transition(s), between the first and second portions 56a, 56b of the crop material 50. The resulting segmentation can aid in the precise identification of a height division between those portions 56a, 56b of the crop material 50.

Referencing the example, provided in FIG. 6, the signal strength corresponding to three of the illustrated data points (p₁, p₂, p₃) are anticipated to be correlated to dielectric constants that satisfy the first threshold value (x1). Therefore, the spatial location information also derived from the those three data points (p₁, p₂, p₃), in view of those data points being determined by the controller 202 to relate to stalks 52, can be used by the controller to determine at least some of the locations among the crop material 52 that are occupied by stalk 52. Similarly, in the example provided by FIG. 6, two of the illustrated data points (p₄, p₅) are anticipated to be correlated to dielectric constants that satisfy the second threshold value (y1). Therefore, the spatial location information also derived from the those two data points (p₄, p₅), in view of those data points being determined by the controller 202 to relate to leaves 54, can be used by the controller 202 to determine at least some of the locations among the crop material 52 that are occupied by leaves 54. While the example shown in FIG. 6 only depicts five data points (p₁ ... p₅) the crop sensor 138 can collected a plurality of data points (p₁ ... pₙ) such that the identified crop elements (e.g., stalks 52 and leaves 54), and the corresponding locations of those identified crop elements, provide sufficient information to derive a location of separation or transition of the first and second portions 56a, 56b (e.g., stalks 52 and leaves 54) such that the controller 202 can identify a target cutting height 144 for the topper assembly 110 to cut the second portion 56b from the first portion 56a of the crop material 50.

Optionally, at block 512, the method 500 can involve identifying operator preferences, including preferences regarding the size and upstream locations of different areas ahead of the agricultural vehicle 100 that the system 200 is to analyze. The system 200 can be configured to receive, or otherwise analyze, input from the user interface 220 to identify such preferences. For example, referencing FIG. 6, such preferences can include a setting regarding the distance ahead of the agricultural vehicle 100, or a location of the crop material relative to the agricultural vehicle 100, or portion thereof, as generally represented in FIG. 6 by a first distance (d₁), upstream from a reference location (as generally indicated in FIG. 6 by “ref₁”) of the agricultural vehicle 100, or portion thereof, at which system 200 is to start collecting information regarding an area (as generally indicated by a₁ in FIG. 6) of crop material 50. The first distance (d₁) can be based a variety of considerations, including, but not limited to, inherent system latencies, including latencies related to the collection and analysis of information by the system 200, as well as in terms of time for completing an adjustment in the height of the topper assembly 100, among other considerations. Additionally, according to certain embodiments, inputs can be provided regarding a size of the area (a₁) and/or a second distance (d₂) that can limit how far ahead of the agricultural vehicle 100, or beyond the first distance (d₁), the system 200 is to collect information for a particular area (a₁). Thus, according to certain embodiments, the differences between the first and second distances (d₁, d₂) can identify the size of the illustrated area (a₁) that is to be considered when determining the corresponding height settings for the topper assembly 110, or portions thereof, for that area (a₁). Information regarding other, downstream areas (a2 . . . aₙ) can be generally continuously obtained as the agricultural vehicle 100 continues traveling along the field so as to accommodate dynamic adjustment of the height of the topper assembly 110 as the agricultural vehicle 100 is harvesting crop material 50. Thus, in certain instances, settings relating to the size of the areas (a₁ . . . aₙ) can impact how often the cut location for the crop material 50 is adjusted, if needed, and thus how often a corresponding adjustment is made to the height of the topper assembly 110.

These operator preferences can be stored in the memory device 206, allowing the controller 202 to adjust the processing and analysis of crop material 50 based on the historical or real-time settings specified by the operator. This capability can facilitate tailored harvesting operations, optimizing the system 200 to cater to specific operator requirements and harvesting conditions. While the foregoing example discusses settings in terms of operator preferences, alternatively, or additionally, one or more, if not all, such settings can instead be preset, default, or factory set settings, and can be based, at least in part, on corresponding system 200 latencies.

At block 514, the controller 202 can utilize the information from one or more, if not all, of blocks 502 to 512 to create a point cloud representation of at least the first portion 56a of the crop material 50, and, moreover, of the stalks 52. This point cloud representation, which can, for example, be a three-dimensional representation, can provide a detailed spatial mapping of the crop material 50, specifically identifying individual stalks 52 within the field of view of the crop sensor 138. Using the combined spatial and dielectric characteristics of detected crop elements, the system 200 can analyze at least the point cloud dataset to discern the precise locations and dimensions of the stalks 52, including identifying a location at which crop material 50 can transition from the first portion 56a (e.g., stalk 52) to the second portion 56b (e.g., leaves 54) of the crop material 50. Such three-dimensional representations of the crop material 50 can be used to determine a three-dimensional location or plane along which the corresponding collection of crop material is to be cut.

The creation and analysis of the point cloud representation can allow the controller 202 to create an accurate model of the agricultural environment in real-time, facilitating the dynamic adjustment of the height setting of the topper assembly 110, including the cutting head 112. By identifying and mapping the boundaries of the stalks 52, including with respect to leaves 54 that can be above the stalk 52, the topper control system 218 can calibrate the cutting height of the topper assembly 110 to an optimal position, thereby increasing the precision of the cut of the associated crop material 50 and thereby reducing the inclusion of undesired leaves 54 in the harvested crop material 50.

At block 516, the method 500 can include implementing an outlier filtering process to enhance the accuracy of information utilized by the system 200. This process can involve the controller 202 examining the point cloud dataset or point cloud representations to identify and remove data points that do not fit within the anticipated ranges of spatial coordinates and dielectric constants. Such a filtering process can further remove noise, interference, anomalies, or reflections from non-target surfaces in the agricultural environment, such as the ground or equipment elements that can not be relevant to an identification of determination of the target cutting height 144, or which may adversely influence the determined location of the target cutting height 144.

The filtering process at block 516 can involve an application of predefined criteria to detect anomalies in the information. For instance, dielectric constants that fall outside the calibrated ranges, such as the first and second thresholds values (e.g., x₁ or y₁) for either stalks 52 or leaves 54, respectively, can be flagged and excluded from at least use in determining a target cutting height 144. Similarly, data points with spatial coordinates that deviate significantly from the estimated profile of the crop material 50 can be identified as outliers. This rejection of outlying data points can assist in at least attempting to ensure that only relevant and accurate information informs the determination of the target cutting height 144 and/or adjustment of the topper assembly 110, potentially increasing the precision of the crop-cutting operation by maintaining a focus on the target materials.

The location information obtained from the signals received by the receiver 142 and that are part of the point cloud dataset can exist within a reference frame of the crop sensor 138, including, for example, in a radar reference frame. Thus, at block 518, the controller 202 can use one or more transformation algorithms to alter such location information, or determinations made using such information, including with respect to the location of the target cutting height 144, from the reference frame of the crop sensor 138 to another reference frame of the agricultural vehicle 100, including a reference frame of the topper assembly 110. Such a transformation can involve utilizing a known relationship, including known geometries of the agricultural vehicle 100, including with respect to the known locations of the crop sensor 138 and topper assembly 110, or portion thereof. According to certain embodiments, such transformation can involve transforming a determined location of a transition between the first and second portions 56a, 56b of the crop material 50 and/or a target cutting height 144 that had been derived relative to the reference frame of the crop sensor 138 to another relative location, such as a location that is relative to a reference frame associated with the topper assembly 110. Such transformation of location information to a reference frame associated with, or relative to, the topper assembly 110 can further assist with the topper assembly 110 being set, or adjusted to, the appropriate vertical cutting height.

At block 520, the relative location information regarding the position of agricultural material elements and/or target cutting height 144, as transformed at block 5198, can be evaluated with respect to the location or positions of the agricultural vehicle 100, or portions thereof, including the topper assembly 110. For example, the determined target cutting height 144, as transformed at block 518, can provide an indication of a distance from a reference location, such as, for example, the ground, at which the topper assembly 110 is to cut the crop material 50. Additionally, at block 520, a current height of the topper assembly 110 can be determined, including, for example, via use of one or more of the height sensors 212 or extent the boom actuator 116 is, or is not, actuated, as previously discussed. Using such information, the controller 202 can determine the location, such as, for example, a present location of the topper assembly 110, or portion thereof, relative to the target cutting height 144. Such information can be used to determine if the height of the topper assembly 110 is to be adjusted, such as, for example, via one or more signals generated by the controller 202 for operation of the boom actuator 116, and, if the height is to be adjusted, the extent the height of the topper assembly 110 is to be changed to align the topper assembly 110 to cut the crop material 50 along the determined target cutting height 144.

The relative location determination at block 520 can, according to some embodiments, incorporate reference vectors and angles, as well as involve consideration of dynamic variations that can be introduced by the motion or orientation of the agricultural vehicle 100. Thus, orientation information, such as information from the IMU 214, can assist the controller 202 in compensating for any variations in pitch, roll, or yaw that can influence the identified location of the target cutting height 144. By integrating such dynamic feedback, the system 200 can at least attempt to ensure accurate spatial calculations are made in relation to the terrain and vehicle 100 movement, thereby further assisting in guiding the topper control system 218 in real-time height adjustments of the topper assembly 110 for effective cutting performance and minimal leaf inclusion.

If, in view of at least the identified relative locations of the target cutting height 144 and the height of the topper assembly 110 indicates the height of the topper assembly 110 is to be adjusted, such an adjustment can occur at block 522. According to certain embodiments, the adjustment of the height of the topper assembly 110 using the boom actuator 116 can involve receiving signals from the controller 202. The timing of at least initiation of adjustments, if any, to the height of the topper assembly 110 in view of possible variances in the location of the target cutting height 144 as the agricultural vehicle 100 traverses across a field can also incorporate inherent system latencies such that the topper assembly 110 is properly positioned to cut along the target cutting height 144 at least upon arrival to a location corresponding to that target cutting height 144.

As the agricultural vehicle 100 harvests a field, the method 500 can be generally continuously performed such that the target cutting height 144 can be dynamically adjusted to reflect possible changes or variations in the location of separation or transition between the first and second portions 56a, 56b (e.g., stalks 52 and leaves 54). Thus, for example, while the topper assembly 110 is cutting crop material 50 in a first area (a₁) along a first target cutting height 144 determined using the method 500, the controller 202 may, using the method 500, have already determined, and/or is in the process of determining, from subsequent information provided by the crop sensor 138, whether the target cutting height 144 is, or is not, to change, and the extent of such a change, for one or more upcoming areas of the field downstream from the first area (a₁). Such an approach can thereby accommodate dynamic adjustments to the cutting height of the topper assembly 110 that can promote efficient and accurate harvesting of crop material while minimizing harvesting of waste.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An agricultural vehicle comprising:
a cutter assembly configured to separate a second portion of a crop material of a first plurality of crop material from a first portion of the crop material of the first plurality of crop material;
a crop sensor configured to transmit, during a harvesting operation, a first plurality of transmitted signals and receive a first plurality of reflected signals;
at least one processor; and
a memory coupled with the at least one processor, the memory including instructions that when executed by the at least one processor cause the at least one processor to:
determine, for each reflected signal of the first plurality of reflected signals: (1) a location corresponding to a reflection of the reflected signal, and (2) a dielectric constant corresponding to a signal strength of the reflected signal;
determine, from the location and the dielectric constant determined for at least some reflected signals of the first plurality of reflected signals, a first target cutting height for separating the second portion from the first portion of the crop material of the first plurality of crop material; and
generate one or more signals to adjust a cutting height setting for the cutter assembly using the first target cutting height.

2. The agricultural vehicle of claim 1, wherein the memory further includes instructions that when executed by the at least one processor cause the at least one processor to:
determine, for each reflected signal of a second plurality of reflected signals reflected from a second plurality of crop material located downstream of the first plurality of crop material: (1) a location corresponding to a reflection of the reflected signal of the second plurality of reflected signals, and (2) a dielectric constant corresponding to a signal strength of the reflected signal of the second plurality of reflected signals;
determine, from the location and the dielectric constant determined for at least some of the reflected signals of the second plurality of reflected signals, a second target cutting height for separating a second portion from a first portion of a crop material of the second plurality of crop materials; and
generate one or more signals to adjust the cutting height setting for the cutter assembly using the second target cutting height.

3. The agricultural vehicle of claim 1, wherein the cutter assembly is a topper assembly.

4. The agricultural vehicle of claim 1, wherein the crop sensor is a radar based sensor.

5. The agricultural vehicle of claim 1, wherein the first target cutting height is represented in three-dimensions along the first plurality of crop material.

6. The agricultural vehicle of claim 1, wherein the memory further includes instructions that when executed by the at least one processor cause the at least one processor to identify the signal strength of each reflected signal of the first plurality of reflected signals.

7. The agricultural vehicle of claim 1, wherein the memory further includes instructions that when executed by the at least one processor cause the at least one processor to determine whether each reflected signal of the first plurality of reflected signals corresponds to one of the first portion or the second portion of the crop material based on a comparison of the dielectric constant with one or more threshold values.

8. The agricultural vehicle of claim 1, wherein the memory further includes instructions that when executed by the at least one processor cause the at least one processor to construct, using the location and the dielectric constant determined for at least some of the reflected signals of the first plurality of reflected signals, a three-dimensional representation of the crop material.

9. The agricultural vehicle of claim 8, wherein the memory further includes instructions that when executed by the at least one processor cause the at least one processor to determine, using at least the three-dimensional representation of the crop material, the first target cutting height.

10. The agricultural vehicle of claim 8, wherein the memory further includes instructions that when executed by the at least one processor cause the at least one processor to generate a signal to operate a boom actuator to adjust the cutting height setting for the cutter assembly to align a cutting head of the cutter assembly with the first target cutting height.

11. A method for dynamically adjusting a cutting height of a cutter assembly of an agricultural vehicle, the method comprising:
receiving, by a crop sensor during a harvesting operation, a plurality of reflected signals reflected from an agricultural environment;
determining, by a controller, for each of at least some reflected signals of the plurality of reflected signals, a dielectric constant corresponding to a signal strength of the reflected signal;
identifying, by the controller using the dielectric constant of the at least some reflected signals, a first group of reflected signals and a second group of reflected signals;
identifying, using a location derived from each of the at least some reflected signals, a transition location or a separation location between the first group of reflected signals and the second group of reflected signals along a crop material in the agricultural environment;
determining, from the transition location or the separation location, a target cutting height for the crop material; and
adjusting, in response to a signal generated by the controller, the cutting height of the cutter assembly to set the cutter assembly to cut the crop material at the target cutting height.

12. The method of claim 11, wherein the first group of reflected signals represent a stalk of the crop material, and the second group of reflected signals represent one or more leaves of the crop material, and wherein the cutter assembly is a topper assembly.

13. The method of claim 11, further comprising:
updating, using another plurality of reflected signals received by the crop sensor as the agricultural vehicle traverses across a field, the target cutting height to provide an updated target cutting height; and
adjusting, in response to a signal generated by the controller, the cutting height of the cutter assembly to correspond to the updated target cutting height.

14. The method of claim 11, wherein adjusting the cutting height of the cutter assembly further comprises adjusting the cutting height to compensate for a variance in at least one of a terrain and an orientation of the agricultural vehicle.

15. The method of claim 11, further comprising determining, by the controller, the signal strength for the plurality of reflected signals.

16. The method of claim 11, wherein determining, from the transition location or the separation location, the target cutting height comprises transforming the transition location or the separation location to a reference frame of the cutter assembly.

17. The method of claim 11, further comprising constructing, using the location derived from each of the at least some reflected signals, a three-dimensional representation of the crop material, and wherein identifying the transition location or the separation location is based in part on an information provided by the three-dimensional representation of the crop material.

18. The method of claim 11, wherein:
identifying the first group of reflected signals comprises determining the at least some reflected signals for which the dielectric constant satisfies a first predetermined threshold, and
identifying the second group of reflected signals comprises determining the at least some reflected signals for which the dielectric constant satisfies a second predetermined threshold.

19. The method of claim 11, wherein the target cutting height is a three-dimensional plane that extends along the crop material.

20. The method of claim 11, further comprising identifying an operator preference that assist in at least defining a distance from the agricultural vehicle at which the target cutting height is to be determined.
